(19) United States
(12) Patent Application Publication
(10) Pub. No.: US 2026/0095447 A1
(43) Pub. Date: Apr. 2, 2026

(54) DATA FLOW-ORIENTED ACCESS CONTROL

(71) Applicant: SAP SE, Walldorf (DE)

(72) Inventor: Jan HRASTNIK, Sandhausen (DE)

(21) Appl. No.: 18/901,341

(22) Filed: Sep. 30, 2024

(51) Int. Cl. H04L 9/40

(52) U.S. Cl. CPC H04L 63/10

(57) ABSTRACT

A system and method including generating, by a first service on an application stack, a first service request to invoke a second service, the first service having a first access context associated therewith that defines authorization checks related to functions performed by and data processed by the first service; transmitting the first service request from the first service to an access control service with the first access context; receiving, from the access control service, a second access context defining authorization checks relevant to functions and data processing to be performed by the second service to fulfill the first service request; and transmitting the first service request in combination with the second access control to the second service, the second service being enabled to execute the service request using authorization checks defined in the second access context.

### BACKGROUND

Access controls may be used to regulate access to applications and services, including the functions and the data processed, created, and manipulated by the execution of the services and applications. In some instances, applications and services may offer authorization enforcement where authorizations may leverage authorization objects that define access controls to resources and data. For example, authorization fields might be defined to allow the specifying of admissible activities (e.g., “Display”, “Create”, etc.) and criteria for determining the scope of accessible objects (e.g., a sales order type, a product type, etc.) so that a user might be authorized to invoke certain admissible activities for certain specified records. Such authorization checks may be implemented in the application code itself. In some aspects, these authorization checks are defined on a global level in the sense that they are decoupled from any concrete service usage. In many applications, authorization checks may be performed independently of each other and at different levels of the application stacks. In some instances, these factors may result in less efficient processing by the applications and services and in the greater use of resources, as well as an increased risk for data inconsistency and the under-or over-provisioning of authorizations to users.

Accordingly, it would therefore be desirable to provide a framework or infrastructure to provide access controls specific to an associated service, where the access controls may be defined without unwanted side-effects and with a high degree of configurability, defined on a service instance level, and applicable to extensions of the services and functions therein.

### BRIEF DESCRIPTION OF THE DRAWINGS

FIG. 1 is an illustrative depiction of an application stack;

FIG. 2 is an illustrative depiction of an application stack for a Manage Products service, in accordance with an example embodiment herein;

FIG. 3A is an illustrative listing of the entities for the OData service of the application stack in FIG. 2, in accordance with an example embodiment herein;

FIG. 3B is an illustrative listing of the entity instance relations for the OData service of the application stack in FIG. 2, in accordance with an example embodiment herein;

FIG. 3C is an illustrative listing of the operations for the OData service of the application stack in FIG. 2, in accordance with an example embodiment herein;

FIG. 4 is an illustrative depiction of some operations, in accordance with an example embodiment herein;

FIG. 5A is an illustrative listing of access control options defined for the OData service of the application stack in FIG. 2, in accordance with an example embodiment herein;

FIG. 5B is an alternative illustrative listing of the access control options defined for the OData service of the application stack in FIG. 2, in accordance with an example embodiment herein;

FIG. 6 is an illustrative listing of authorizations granted to a user for the OData service of the application stack in FIG. 2, in accordance with an example embodiment herein;

FIG. 7 is an illustrative listing of a user issued service request for the OData service of the application stack in FIG. 2, in accordance with an example embodiment herein;

FIG. 8A is an illustrative listing of the entities for the BO service of the application stack in FIG. 2, in accordance with an example embodiment herein;

FIG. 8B is an illustrative listing of the entity instance relations for the BO service of the application stack in FIG. 2, in accordance with an example embodiment herein;

FIG. 8C is an illustrative listing of the operations for the BO service of the application stack in FIG. 2, in accordance with an example embodiment herein;

FIG. 9 is an illustrative listing of access control options defined for the BO service of the application stack in FIG. 2, in accordance with an example embodiment herein;

FIG. 10 is an illustrative listing of a service request for the BO service of the application stack in FIG. 2, in accordance with an example embodiment herein;

FIG. 11 is an illustrative listing of a new access context for the BO service of the application stack in FIG. 2, in accordance with an example embodiment herein;

FIG. 12A is an illustrative listing of a service request in SQL syntax for the database service in the application stack in FIG. 2, in accordance with an example embodiment herein;

FIG. 12B is an illustrative listing of a service request in JSON notation for the database service in the application stack in FIG. 2, in accordance with an example embodiment herein;

FIG. 13A is an illustrative depiction of an application stack for a Manage Products service and a reference service model used thereby, in accordance with an example embodiment herein;

FIG. 13B is an illustrative listing of the entities for the reference service model in FIG. 13A, in accordance with an example embodiment herein;

FIG. 13C is an illustrative listing of the entity instance relations for the reference service model in FIG. 13A, in accordance with an example embodiment herein;

FIG. 13D is an illustrative listing of the operations for the reference service model in FIG. 13A, in accordance with an example embodiment herein;

FIG. 13E is an illustrative revised listing of the entities for the reference service model in FIG. 13A, in accordance with an example embodiment herein;

FIG. 13F is an illustrative listing of mappings between the service models and the reference service model in FIG. 13A, in accordance with an example embodiment herein;

FIG. 14A is an illustrative depiction of an application stack for a Manage Sales Orders service, in accordance with an example embodiment herein;

FIG. 14B is an illustrative listing of the entities for the Manage Sales Orders service in FIG. 14A, in accordance with an example embodiment herein;

FIG. 14C is an illustrative listing of the service operations for the Manage Sales Orders service in FIG. 14A, in accordance with an example embodiment herein;

FIG. 14D is an illustrative listing of the access control options for the Manage Sales Orders service in FIG. 14A, in accordance with an example embodiment herein;

FIG. 15 is an illustrative listing of the reference service model for the Manage Sales Orders service in FIG. 14A, in accordance with an example embodiment herein;

FIG. 16 is an illustrative listing of authorizations granted to a user for the Manage Sales Orders service in FIG. 14A, in accordance with an example embodiment herein;

FIG. 17 is an illustrative listing of a user issued OData service request for the Manage Sales Orders service in FIG. 14A, in accordance with an example embodiment herein;

FIG. 18 is an illustrative listing of an access context for the Manage Sales Orders service in FIG. 14A, in accordance with an example embodiment herein;

FIG. 19 is an illustrative listing for an extension of access control options for the Manage Sales Orders service in FIG. 14A, in accordance with an example embodiment herein;

FIG. 20 is an illustrative depiction of a system architecture, according to an example embodiment;

FIG. 21 is an illustrative process flow, according to an example embodiment; and

FIG. 22 is an illustrative computing system, according to an example embodiment.

### DETAILED DESCRIPTION

The following description is provided to enable any person in the art to make and use the described embodiments. Various modifications, however, will remain readily apparent to those in the art.

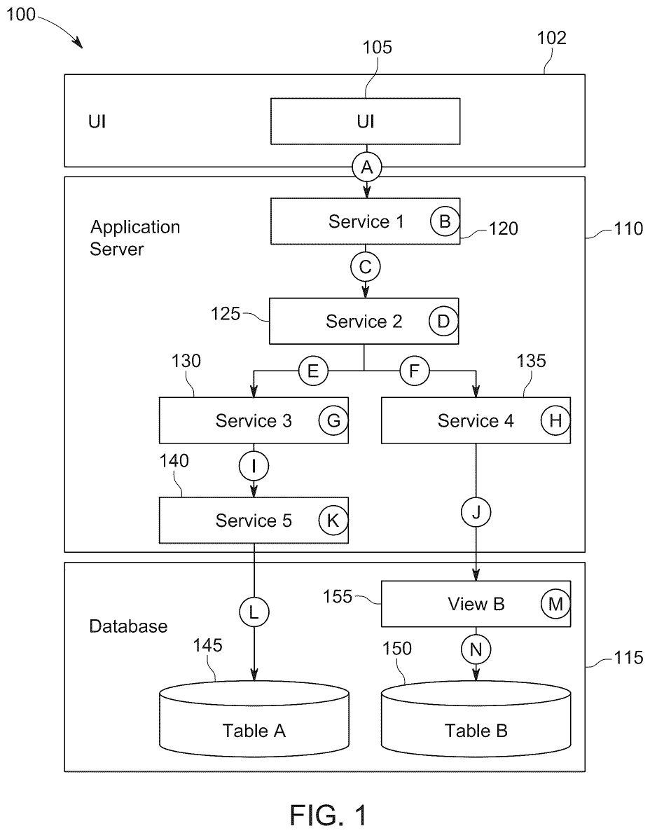

Prior to a detailed discussion of the novel aspects of the present disclosure, a brief overview of a sample application stack 100 as illustrated in FIG. 1 for which access controls of the present disclosure might be defined for, associated, and used with is provided. Application stack 100 comprises a user interface (UI) 102, an application server 110, and a database layer 115. In some aspects, UI 105 might leverage Service 1 (120) that in turn leverages Service 2 (125) within the application server. In some instances, Service 2 (125) may dispatch service requests or calls to Service 3 (130) and Service 4 (135). Service 3 (130) might invoke Service 5 (140), which accesses Table A (145) of the database layer 115. In some instances, Service 4 (135) might access data via View B (155) that fetches data for the view from Table B (150).

In some aspects, the architecture of the application stack depicted in FIG. 1 might be typical for ABAP (Advanced Business Application Programming) applications. However, at least some of the features of the example application stack in FIG. 1 may also be applicable to other types of applications.

In some aspects, access controls may be applied at various levels within application stack 100, as indicated by the markers “A” through “N”, including before, after, or in-between the service calls. Referring to FIG. 1, a start authorization regarding whether a user is allowed to use the Service 1 might be executed at point “A”, where some instance restrictions might be implemented to immediately stop a specific request with an error if certain constraints are met. In some embodiments, a filter restriction might be implemented so that although a user is, for example, authorized to access some data without restrictions, some records the user is not authorized to view will be filtered out before results are returned to the user. These and other types of authorization checks or access controls might occur when there is communication between the different services, during an execution of a service, when delegating a request or function to another service call, etc.

Still referring to FIG. 1, some prior methods and processes for implementing authorizations checks applied authorizations on a global level, where an authorization check is not associated with any particular service usage. Accordingly, authorizations in some such systems will not only perform an authorization check at, for example, level “A” within the top level service of application server 110 where an authorization check is explicitly triggered, but also perform the authorization check when there is a delegation to another service (e.g., Service 2 will also perform the authorization checks). As a result, the same authorization check(s) might be run multiple times because the services within the application stack are not typically aware of each other and every service needs to ensure that only authorized users and authorized operations are being processed. The repeated execution of the same authorization check(s) may present a problem from a performance perspective because all of the repeated checks can be quite time consuming and prove redundant without adding any additional security benefits while also consuming additional overhead.

In some aspects, the present disclosure relates to an infrastructure and framework referred to herein as data flow-oriented access control (DFOAC) that focuses on enabling authorization checks once, where appropriate and necessary. The overall access control for the disclosed DFOAC infrastructure or framework (used interchangeably herein unless noted otherwise) may be split into different, more fine-grained access controls that are applied over different levels of an application stack. However, these divided or partial authorization checks may advantageously be performed without redundancies. In some aspects, both functional and data related checks might be combined in the access controls disclosed herein. In some embodiments, each service of an application stack might declare its supported access control options in a transparent way based on the actual service or on a reference data and operation model, such that the DFOAC access enforcement disclosed herein may be considered fully comprehensive and easily understood.

In some aspects, the DFOAC infrastructure disclosed herein is highly configurable, providing a high degree of freedom in defining access restrictions, including fine granular access controls on both an instance level and a value level, as well as supporting extension options thereof.

In some aspects, the DFOAC infrastructure herein defines an access context that may be created on an uppermost level of the application stack in a trusted environment, for example, an application server (e.g., ABAP) and attached to a dedicated data flow being triggered when invoking a service therein. The invoking infrastructure or service passes the access context along or together with the actual service request to the invoked service. As discussed in greater detail below, an access context herein may contain information regarding whether access control(s) are to be applied and which access control(s) are to be applied. For its part, the invoked service may analyze the access context and apply it as specified. In some aspects, before delegating calls to other services, a new access context may be created by a service (e.g., an invoked service) based on the received access context and on the local processing logic of a given service, wherein already processed authorization checks might be removed therefrom and the invoked service adapts the received access restrictions based on the access control options of the invoked service. In this manner, some embodiments herein may logically result in a hierarchy of access contexts, with each access context being specific to the concrete service invocation(s) to avoid overlaying issues in nested call scenarios or when processing services in parallel.

Note that since the authorizations herein may be granted and enforced specifically per dedicated service, authorizations can be granted tailored to the actual tasks of the users without the risk of over-provisioning access rights. Moreover, since the actual access control options may be declared transparently, the risk of under-provisioning authorizations due to missing insights into the actual data processing logic and its access control enforcements can be minimized.

In some aspects, the DFOAC infrastructure disclosed herein supports extensions of the access control options including code exits. In some embodiments, these extensions might work “out-of-the-box” for fully modelled application stacks (e.g., RAP, RESTful Application Programming Model, managed service scenarios, etc.). In some instances in accordance with the present disclosure, the extensions may be robust against unintended side effects since they can be embedded end-to-end in a manner that is well-defined by the extender.

In some embodiments, the DFOAC infrastructure disclosed herein may be incorporated into new applications, as well as be applied to legacy applications to replace or modify (i.e., change in part) existing access control handling in the legacy applications. A step wise adaption of legacy apps to the DFOAC concept may be feasible.

Some aspects and features of the DFOAC infrastructure of the present disclosure will be described in the context of exemplary applications to demonstrate technical features of the DFOAC infrastructure, as well as useful, practical integrations of the DFOAC infrastructure with services.

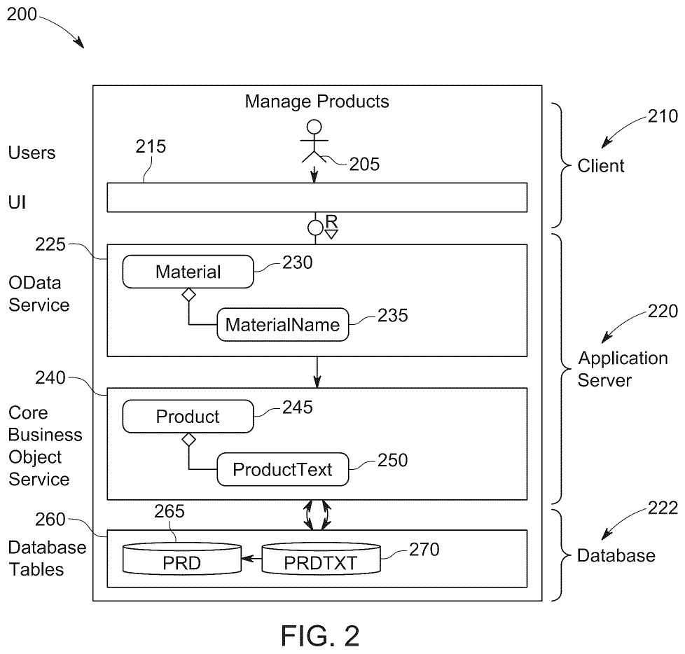

FIG. 2 is an illustrative depiction of an application stack 200 for a Manage Products service or application, in accordance with an example embodiment herein. In this example, application Manage Products generally provides functionality that enables a user to display and maintain data records related to products. In the example of FIG. 2, the “Manage Products” application stack 200 comprises a client 210, an application server 220, and a database 222. The client includes a UI 215 that a user 205 may interact with to enter or submit requests of the application and receive responses to such requests from the service(s) of the application. UI 215 may be a browser-based UI that allow users to issue calls to OData service 225 providing access to the functionality and data of the application. In this example, OData service 225 may be based on a core business object (BO) service implementation 240 that stores and selects data from database tables 260, including product tables 265 and product text tables 270.

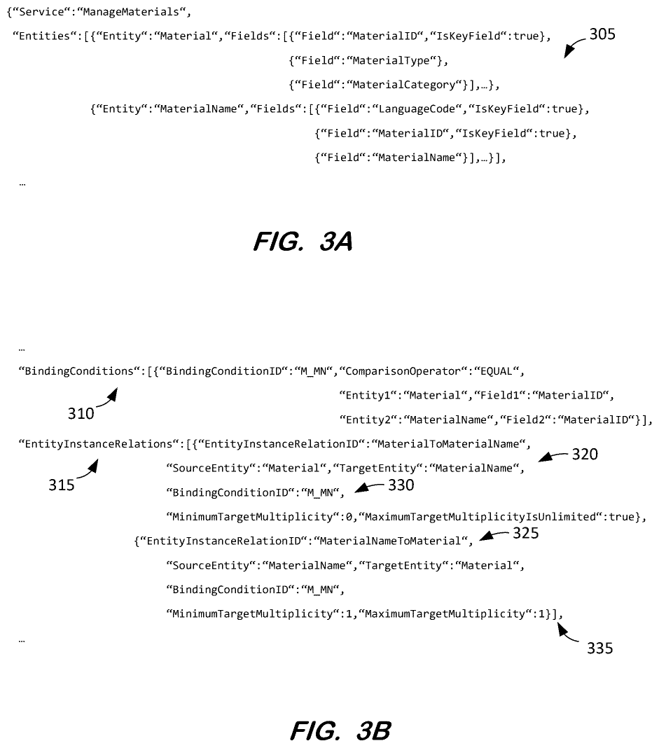

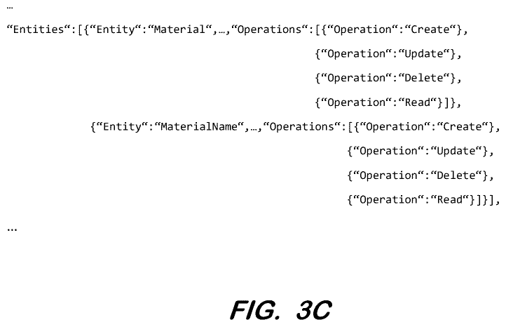

With reference to the example of FIG. 2, aspects of the present disclosure will now be illustrated by a discussion of example entities that might be used to implement some features disclosed herein. In this context, metadata descriptive of the services of application stack 200 will be expressed in JSON notation (although not limited thereto) for illustration purposes. FIG. 3A is an illustrative listing of the entities for the OData service of the application stack in FIG. 2. As illustrated at 305, the OData service “ManageMaterials” includes the entities “Material” 230 and “MaterialName” 235. The metadata listing of FIG. 3A includes a description of the entities (e.g., fields, properties, whether a field is a key field, etc.) comprising this Odata service.

FIG. 3B is an illustrative listing of the entity instance relations for the OData service of the application stack 200. The metadata listing in FIG. 3B defines the relations between entity instances, where the relations may be defined by the illustrative “BindingConditions” 310 and “EntityInstanceRelations” 315. In this example, for the two entities Material and MaterialName, the binding condition connects, using an abbreviation for “Material” and “MaterialName” (i.e., M and MN, respectively), the Material entity with the MaterialName entity on an instance level by the value that is entered in the “MaterialID”. The defined “BindingConditions” can then be used in further operations. The “EntityInstanceRelations” 315 describes these entity instances in more detail. For example, the “Material” to “MaterialName” relation is defined, as well as the starting or source entity is the “Material” entity and the target entity is the “MaterialName” entity. The previously defined “BindingConditions” is used to capture the relation on an instance level and it can be attributed with additional properties (e.g., a minimum (“0”) and a maximum (“unlimited”) number of records). The “MaterialToMaterialName” relation 320 is a directed relation. As such, the “MaterialNameToMaterial” relation 325 is also defined, which is the opposite or reverse direction from “MaterialToMaterialName” entity instance relation defined above. Here, the source entity is the “MaterialName” entity and the target entity is the “Material” entity. Note that the same binding condition 320 is used for the “MaterialNameToMaterial” relation as was used for the “MaterialToMaterialName” relation, where the “MaterialID” field (e.g., M and MN) is used to map the entity instances. However, for this instance relation from the MaterialName to Material, there will be exactly 1 partner. That is, if there is a Material Name, then there will be exactly 1 matching Material, as seen at 335.

Accordingly, FIGS. 3A and 3B are listing of metadata describing what comprises the data model for the Manage Products service application and how the features thereof are related.

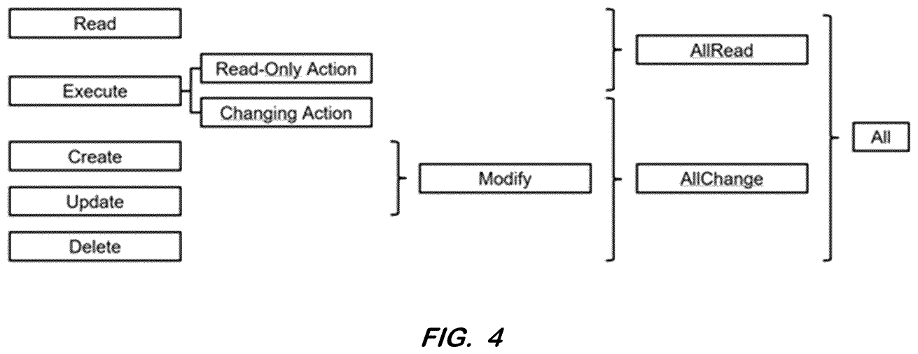

FIG. 3C is an illustrative listing of the operations for the OData service of the application stack 200, where the operations provide a mechanism for the service to retrieve and manipulate data. Some aspects of the operations referenced in FIG. 3C (and elsewhere herein) are illustrated in the example operations depicted in FIG. 4 where different service operations may be defined for an entity of a service (e.g., the entities “Material” and “MaterialName”).

FIG. 4 includes the operations of Create, Read, Update, Delete, and the action Execute, all of which are defined for use by a service (e.g., the “Material” and “MaterialName” entities in FIG. 3C). The Create, Update, and Delete operations may collectively be referred to as a Modify operation. As illustrated, the Execute action may be a read-only action or a changing action. In general, the DFOAC infrastructure herein distinguishes between read-only and changing actions according to FIG. 4. As such, the Create, Update, and Delete operations and the changing action of the Execute operation may collectively be referred to as All Change operations, whereas the read-only action of the Execute operation and the Read operation may collectively be referred to as All Read operations. The All Read operations and the All Change operations together constitute all of the operations in the example of FIG. 4. In some embodiments, the operations defined for an entity may differ from those illustrated in FIG. 4. The operations and terminology illustrated in FIG. 4 are used in the subsequent definitions and examples of the present disclosure.

The metadata listings of FIG. 3A - 3C describe the “Manage Products” service from a modeling perspective. The illustrated metadata relates to DFOAC infrastructure disclosed herein. In some aspects, it is an abstraction of the actual service definitions and may be universally applicable to any service (e.g., OData, SOA, plain REST, RAP, SQL, and the like) allowing DFOAC to support multiple different consumption scenarios. For fully declarative services, the metadata may be automatically derived from the original service metadata such as, for example, an OData metadata document of the OData service itself. Note that the DFOAC metadata may be captured in JSON notation as shown above in the present example or captured/expressed differently. However, the present example and following examples express the metadata in JSON representation as a matter of choice, not necessity.

As seen in FIG. 4, from an operations perspective, there are different operations such as, Read, Create, Update, and Delete (i.e., CRUD), but there can also be actions (e.g., Execute). Regarding the actions and functions, the DFOAC infrastructure or framework herein distinguishes between read-only actions and change actions. A read-only action herein might include, by example, performing a check that simply returns information or a calculator that operates to calculate the result of a formula to provide a response without changing the data by working on input data and returning some output. There are also actions that actually change information within the system (e.g., update a product record). As such, from an authorization perspective, read-only actions and changing actions may be distinguished from each other.

Note, that whereas the mentioned CRUD operations are bound to instances of the service entities, actions may be static or instance-bound and may be defined on a service-level or a specific service entity.

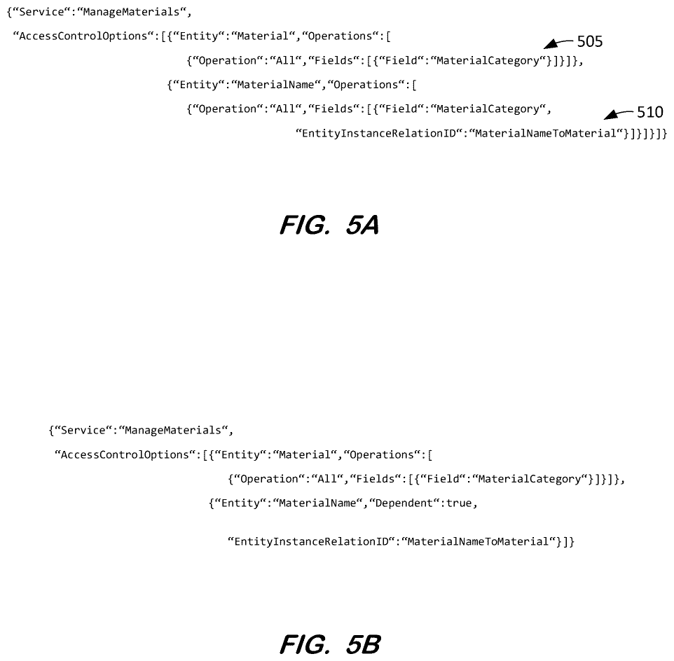

In addition to the metadata describing the data and functionality that a service offers (e.g., FIG. 3A-3C), each service is expected to document its supported access control based on a service model. FIGS. 5A and 5B illustrate example definitions of access control options for a service of the application stack 200. The illustrated metadata shall be in-line with the actual service implementation and serves as a baseline for defining service-specific user authorizations. In some aspects, it provides full transparency about the admissible access controls. Of note, since it is referring to the protected service itself, it is easy to interpret and understand.

A significant technological improvement provided by the DFOAC infrastructure and framework herein is that for a service (e.g., an Odata service or other type of service) access control options, if any exist, are captured on a service level. For example, access control options might define user access to the service, configurable access options, where in a process flow access controls are performed, etc. An example of this aspect is depicted in the JSON expressions in FIG. 5A where an example of some of the supported access controls for a service (e.g., an OData service) are defined. FIG. 5A is an illustrative listing of access control options defined for the OData service of the application stack 200 (i.e., the kinds of access granted for the service when the service is used) are defined. As illustrated in FIG. 5A, all accesses to the functionality and data offered by the “Manage Materials” service (operation=“All”) is governed by the field “MaterialCategory” of the service entity “Material”, as seen at 505. This applies to both entities “Material” and “MaterialName”. For the latter (shown at 510), access on the instance level is declared based on the relation “MaterialNameToMaterial” that relates instances of entity “MaterialName” with instances of entity “Material” holding the access controlling field “MaterialCategory”. The static relationship is also derived from this instance relationship.

According to FIG. 5A, all operations supported by the “Material” entity (i.e., the CRUD operations and the Execute actions) on this “Material” entity level are determined by authorizations based on the “MaterialCategory”. That is, for this example access control for all of the individual operations supported by the service can be defined by the field or the field values for “MaterialCategory”.

FIG. 5A also states similarly defined access control for the associated entity “MaterialName” where all operations are controlled by “MaterialCategory”. “MaterialCategory” itself is not part of this entity “MaterialName”, but as shown above (e.g. FIG. 3B), there is an association relation from the “MaterialName” to the Material that is defined on the entity instance level. This relationship can be leveraged here so that when an instance of the entity “MaterialName” is accessed, an authorization check may be performed via this defined relation to determine whether a user is allowed to perform the requested action or operation. In this present example, all of the defined access controls for both entities are not strictly isolated from each other. Instead, they are linked by the entity instance relationship.

FIG. 5A is an illustrative depiction of an access control option. A developer (or other authorized personnel or entity) of the “ManageMaterialService” may define the access controls that are implemented in the service. That is, in accordance with the present disclosure, for a defined service there is also defined or specified associated access control options for the given service.

In some instances, access control options for a service might be deployed with an associated service as illustrated in the present example. In this manner, by default, the authorization enforcement might be fine-tuned for the service based on the access control(s).

In some aspects, the access control options defined in the present example of FIG. 5A might be typical for some scenarios. In this example, both of the noted entities control all of the access options the same way and the access controls of both entities will be in sync. This pattern of behavior might be maintained in certain scenarios including, for example, single documents or single master data objects where there is a material having name, where a user having access to the “material” itself can also read or do the same operations on the “material name”. This might avoid a situation where a user might be, for example, granted access to read the material ID, but denied access to the material name (i.e., the description or readable part), which is typically not intended.

Intentionally, in the present example the access controls of both entities in the access control options in FIG. 5A shall be in sync. Accordingly, if a user can execute operations on entity “Material”, then they shall also be enabled to execute the same operation on entity “MaterialName” that is associated to the same instance of entity “Material”. In some embodiments, this aspect might be explicitly expressed. FIG. 5B is an alternative illustrative metadata listing of the access control options defined for the OData service of the application stack 200 being expressed in a more explicit manner, as compared to the metadata listing of FIG. 5A. While the declaration in FIG. 5B has the same effect as the declaration in FIG. 5A, the metadata in FIG. 5B explicitly defines the actual dependency between the “Material” and “MaterialName” entities. The explicit definition of the dependency between the two entities in FIG. 5B substantially expresses the same content files, but further specifies that if there is a change to the “Material” entity (e.g., the access control field “MaterialCategory” is changed to or adds another access control field, e.g., MaterialType”), then the same change would also automatically inherit to the “MaterialName” entity. In some aspects, the explicit definition in FIG. 5B might aid in avoiding inconsistencies when, for example, extending the standard access control options.

Note that in the example access control options for the entities “Material” and “MaterialName” in FIG. 5A, in order to have a change to the access control field for the “Material” entity to also be applied to the “MaterialName” entity, the MaterialName entity would also have to be expressly edited. That is, there is no automatic inheritance of the changed access control options from the changed “Material” entity for the access control options as defined in FIG. 5A.

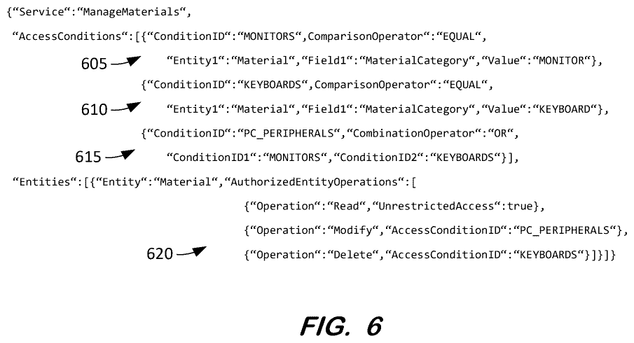

In some aspects, a user may be granted authorizations based on the access control options of the OData service. (i.e., the use thereof) The corresponding authorizations may be defined as outlined in FIG. 6. FIG. 6, is an example, still expressed using JSON notation, of a scenario where an Administrator (or other authorized entity) might grant authorizations to a user based on the access control options of the OData service (i.e., the use thereof) defined in FIGS. 5A, 5B. Per to the user authorizations defined as shown in FIG. 6, access conditions are defined. Here, condition 605 states that the Condition ID is equal to “Monitors” (i.e., named “MONITORS”) when the field “MaterialCategory” of the entity “Material” has a value of “Monitor”. Another condition 610 is similarly defined where a condition named “KEYBOARDS” is defined by the “MaterialCategory” field for the entity “Material” having a value of “KEYBOARD”. Condition 615 is an example of an access condition comprising a combination of conditions where the condition “PC_PERIPHERALS” is defined by a combination of the previously defined conditions of “MONITORS” and “KEYBOARDS”, where either the “MaterialCategory” having the value “MONITOR” or “KEYBOARD” (as defined for those respective conditions) satisfies the conditions for a PC peripheral.

The access conditions 605, 610, and 615 capture and express criteria that may be used in granting authorizations to a user (or other consuming entity). At 620, an example is illustrated of the kind of authorizations that may be granted to the user. Here, authorized operations for the entity “Material” include, for an authorized user of the service, unrestricted (i.e., “UnrestrictedAccess”:true) access for READ operations. For modifying operations (i.e., Create and Update operations), the user is authorized to modify peripheral equipment (“AccessConditionID”:“PC_PERIPHERALS”) that is defined by material of the categories “MONITORS” and “KEYBOARDS” (as specified by condition 615). The user is authorized to perform deletions of instances of “Material” having the category “KEYBOARDS”.

As defined in the declared access control options metadata in FIG. 5B, the “MaterialName” is actually dependent on “Material”. As such, the access conditions or rules defined here for instances of the entity “Material” are inherited to related instances of its dependent entity “MaterialName” (i.e., the “MaterialName” entity is afforded the same authorizations as the “Material” entity).

The foregoing FIG. 3A-3C and 5A-6 disclose, in some aspects, declarative features of the present disclosure. Some aspects will now be disclosed from a processing perspective, including an interaction with a service, such as a service request.

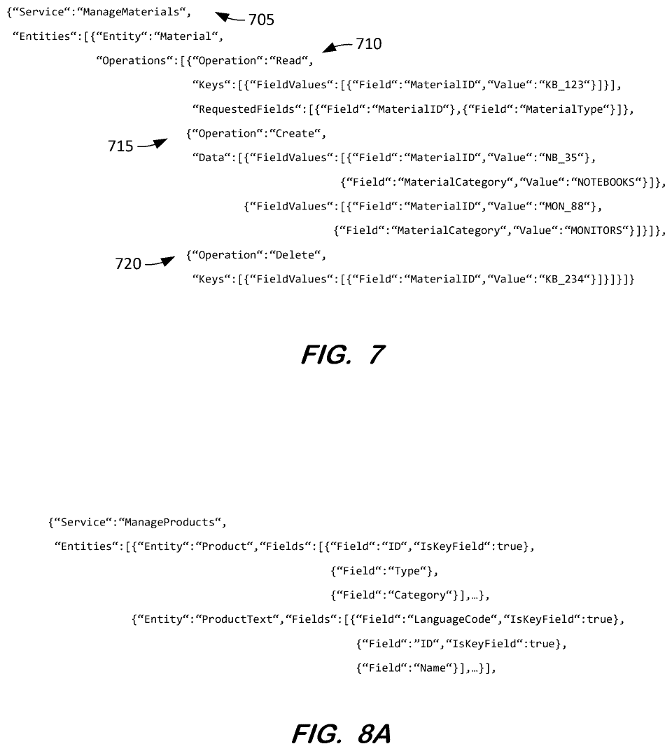

FIG. 7 is an illustrative listing of a user issued service request, issued via UI 215 that interacts with the OData service “ManageMaterials” of the application stack 200 in FIG. 2 and the corresponding metadata for the OData service (e.g., FIG. 3A-3C and 5A-5B). The “ManagedMaterials” service may be invoked by the expression at 705 to trigger, in this example, a service request that includes a combination of three operations. The service request includes a read operation 710 to read some information, an operation 715 to create some new data records, and a delete operation 720. The read is issued on an instance of the entity “Material” by its primary key “MaterialID”=“KB_123” and request the two values for “MaterialID” and “MaterialType”. Since the user was granted unrestricted read access to the entity “Material”, the data can be fetched privileged (i.e., no further authorization checks need to be applied for fulfilling this read request within the internal implementation of the service).

In the same request, there is a request 715 to create two new records, including a record with the “MaterialID”=“NB_35” and the “MaterialCategory”=“NOTEBOOKS” and a record defined with the “Material ID”=“MON_88” and the “MaterialCategory”=“MONITORS”. Since the access controlling field “MaterialCategory” is supplied with values, the specified values may be mapped against the granted user authorizations (without a need to actually read the data) to determine whether the user is authorized to create the requested records. Based on the user granted authorizations in FIG. 6, the user is not authorized to create a Notebook since the user is only allowed to create “PC_PERIPHERALS” that include Monitors and Keyboards. Accordingly, the creation of NB_35 is immediately denied, whereas the creation request for “MaterialID” “MON_88” can be granted immediately based on the supplied category “MONITORS” for which the user was granted authorization (e.g., FIG. 6) and this create request can be further processed without any additional or subsequent authorization check(s).

For the request 720 to delete the instance of entity “Material” defined by its key “MaterialID”=“KB_234”, no further information is provided or available (e.g., the “MaterialCategory” associated with the instance of the Material entity to be deleted is unknown). Accordingly, the authorization check for this delete service request is deferred.

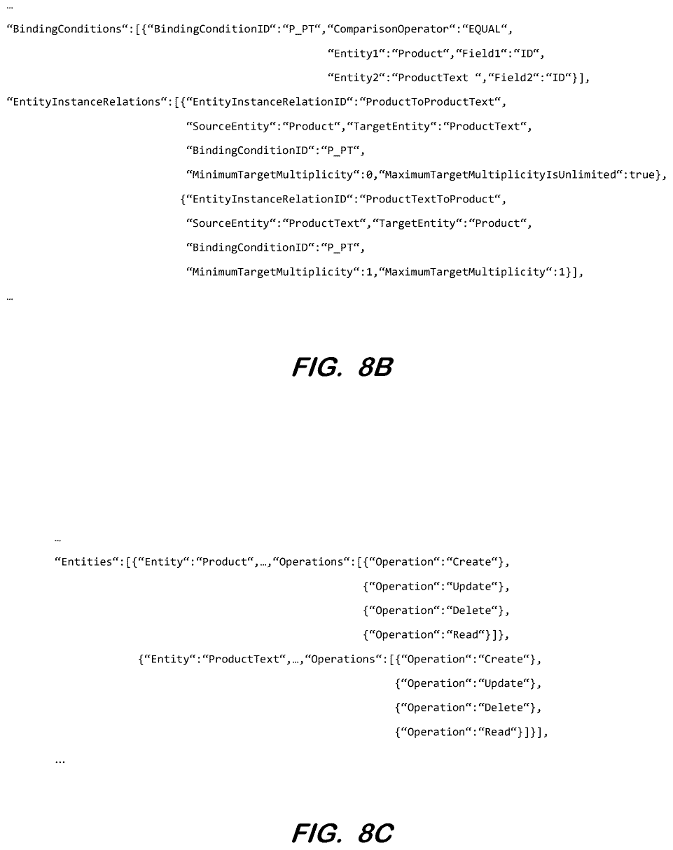

In some aspects, when applying the DFOAC authorization enforcement as captured by the foregoing defined service model, access control options, and user authorizations, all such information may be leveraged for streamlining the authorization checks. In an example where the previously described OData service 225 delegates service requests to an underlying core BO service “ManageProducts” 240, note that the “ManageProducts” service exposes (i.e., is defined as comprising) some entities (FIG. 8A, data model) having certain associated relations (FIG. 8B) and operations (FIG. 8C). As such, FIG. 8A-8C capture the service “ManageProducts” from a metadata perspective. In some aspects, features of FIGS. 8A-8C for the “ManageProducts” service are similar to features of FIGS. 3A-3C for the “ManageMaterials” service. As such, some features of FIG. 8A-8C may be understood to be similar to features of FIG. 3A-3C, without a detailed description of all aspects of FIG. 8A-8C.

FIG. 9 is an illustrative example of access control options defined for the “ManageProducts” service. As seen at 905, in one aspect of this example there is a dependency such that the “ProductText” entity is directly related to the access control options for the “Product” entity.

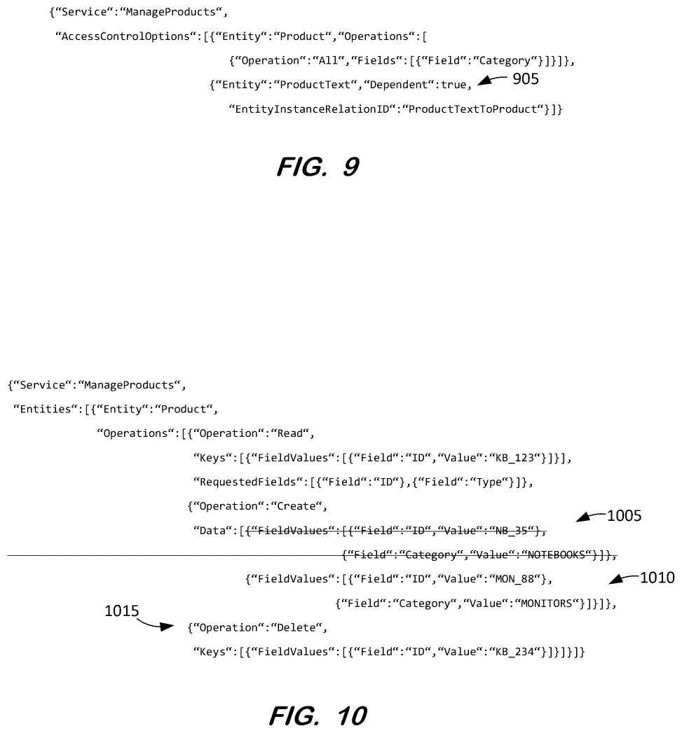

In an illustrative embodiment, this core BO service “ManageProducts” may be invoked with a service request as depicted in the illustrative example of FIG. 10. Note that this service request is being invoked after the “ManageMaterials” service request discussed above with regard to FIG. 7. The “ManageProducts” service request is derived from the original OData service request, filtering unauthorized parts thereof as highlighted in FIG. 10 at 1005. Accordingly, we know from the previous service request that the user was not authorized for the notebooks (see the user granted authorizations defined in FIG. 6). Thus, the service request of FIG. 10 can drop or otherwise filter unauthorized parts of the request (i.e., the portion of this service request to create “NOTEBOOKS”), whereas the other requested create operation shown at 1010 is allowed and is retained in the service request for further processing logic. Also, the original deletion request shown at 1015 that has not yet been determined as being permissible is also retained in the service request.

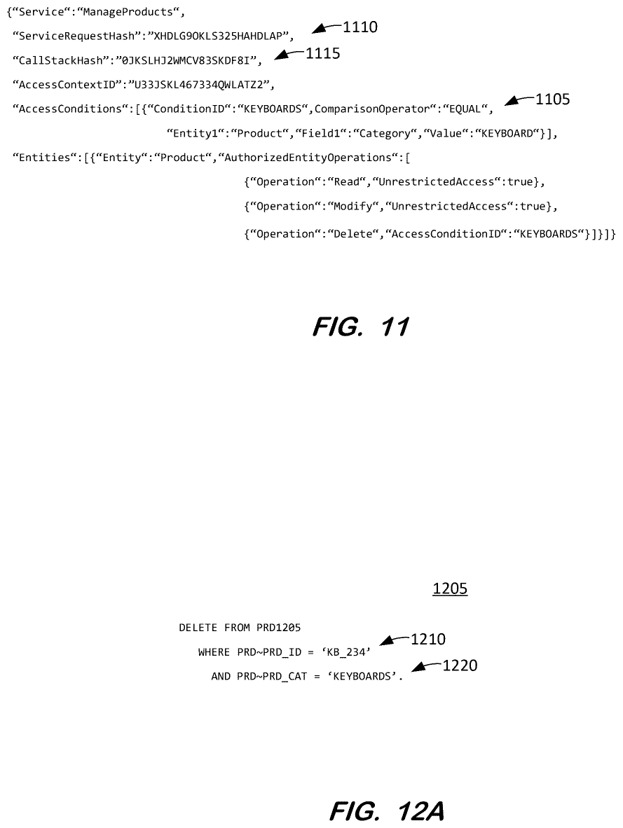

In some embodiments, a new access context is created that considers both the OData service request and the BO service request. This new access context will capture or preserve the information about what kind of authorization checks were already performed and what still needs to be checked in subsequent processing. An illustrative representation of the new access context is depicted in FIG. 11.

Given the service request is delegated to the underlying BO logic from the Odata service, the new access context is created as shown in FIG. 11 where the read operation and modify operation can be performed in privileged mode without having to perform check(s) from an authorization perspective again because these operations have already been validated. However, the delete request has not yet been validated. Therefore, the requested Delete operation is still subject to the listed access conditions shown at 1105.

In accordance with the DFOAC infrastructure and framework disclosed herein, the new access context represented in FIG. 11 may be attached to the service call, i.e., to the BO service “ManageProducts”, and leveraged within the BO service implementation. This access context is tailored to the specific service request to which it is bound and compared to the original user authorizations, only the relevant access conditions are retained in the access context in the example of FIG. 11.

The access context may be passed to the invoked service directly, which may be efficient since it may allow a service to skip its own access controls for the privileged parts of the access request while focusing on determining access for undetermined/deferred authorizations.

In some aspects, the manner in which an access context is passed to an invoked service may vary. For example, in a trusted environment the access context might be passed directly, as a whole or as a pointer (e.g. “AccessContextID”), along with the actual service request to the invoked service. However, such a configuration implies that the services and protocols were adapted to support the DFOAC infrastructure. For some legacy applications and standardized services, this may not be feasible. Instead, the invoked service may have to fetch the access context from a DFOAC access context manager. In order to handle potentially repetitive, recursive and parallel invocations of the same service in the same session, the access context manager may register the newly created access context keeping the information about the bound service request (e.g. as indicated by the “ServiceRequestHash”, FIGS. 11, 1110) and the call stack resulting in the service request (e.g., “CallStackHash”, FIGS. 11, 1115). The invoked service can then request the effective access context from the trusted access control manager by passing the service request along with the call stack information. In turn, the invoked BO service may now start processing the passed service request, skipping its own access control enforcements for all the privileged parts of the service request.

In the present example, only the “Delete” operation still needs to be authorized. To evaluate this restriction, the BO service may first select the data record to be deleted (“ID”=“B_234”) from the underling database service in privileged mode, then check the value of the field “ProductCategory” against the authorized value “KEYBOARDS” and depending on the check result, either issue a deletion service request to the database service (in the event the user is authorized) or reject the execution of the deletion (in the event the user is not authorized). While this approach might work from an authorization perspective, it may not be efficient since it introduces additional processing steps and service calls for establishing an access control.

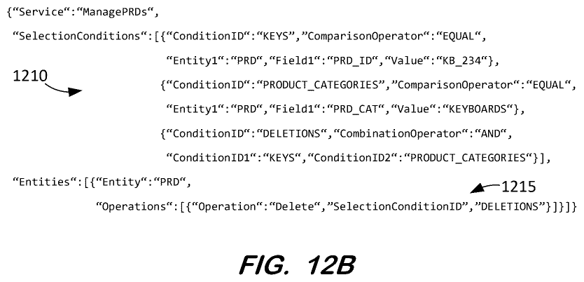

In some embodiments, an access context may be passed to an invoked service as a single service request. As an example, the BO service 240 including a “Product” 245 entity and a “ProductText” 250 entity in FIG. 2 may create a single service request to the database in privileged mode that comprises both the delete operation and the necessary access control. An illustrative depiction of this type of service request implementation is shown in FIG. 12A. The service request 1205 in FIG. 12A is expressed using standard ABAP SQL syntax. In the example of FIG. 12A, one where condition 1210 is used to pass the deletion request, as is, without further enforcements. The other where condition 1220 restricts the deletion request according to the authorizations of the user. If both of the SQL where conditions in service request 1205 are met, then the deletion operation is authorized and the deletion will be executed. Otherwise, no deletion happens. From a processing perspective, authorization checks of the type in FIG. 12A can be applied in a very efficient and flexible manner.

While the service request represented in FIG. 12A is expressed in plain SQL syntax, it may be expressed in a more formal format such as the JSON syntax used to demonstrate other features of the present disclosure. FIG. 12B is a restatement of the service request captured in FIG. 12A, where the service request is expressed using JSON annotations. In FIG. 12B, the service request for the database service “ManagePRDs” includes conditions defined at 1210 and based on these conditions, the desired operation(s) to be perform are defined at 1215.

In some aspects, the compression of the service request in FIGS. 12A and 12B (i.e., the optimization of service request(s)) is facilitated by the transparent, declarative DFOAC approach herein that provides complete control regarding authorization enforcements by a service consumer in a trusted environment.

In some aspects, converting authorization controls into the (standard) processing logic of services as illustrated in the SQL request of FIG. 12A may enable the switching or transformation of legacy infrastructure components to the DFOAC infrastructure or framework disclosed herein, even if partially or gradually. For example, it may be possible to leverage the DFOAC infrastructure or framework disclosed herein for a subset of invoked services that are adapted to the DFOAC infrastructure or framework.

Note that issuing a service request within the processing logic of another service may be admissible based on the infrastructure or framework disclosed herein, even if the user may not be authorized for directly performing the corresponding functionality, since the user authorizations are bound to dedicated services.

As indicated by FIG. 2, different services may be engaged in the data flow of processing user service requests. The different services may not necessarily have the same structures, fields, names, functions, and the like. In some aspects, this was demonstrated by the services in the example application stack 200. In some instances (e.g., cases involving legacy applications), it may be assumed that major differences between the different services exist.

As a technological solution to handle, for example, different services and complex application stacks and processing logic, the DFOAC infrastructure disclosed herein may include an abstraction referred to as a “reference service model”. The reference service model might simplify the handling of access controls within DFOAC by providing a reference model to which the concrete service entities and their functionality may be mapped to. Note that in some embodiments, such a mapping is not mandatory, although it might ease some technical implementation aspects of the DFOAC infrastructure disclosed herein. In some aspects, a reference service model might act or serve as a common denominator for the services in an application stack. In some instances, an existing service (e.g., a core Business Object service (or other service) of an application stack) might be used as a reference model.

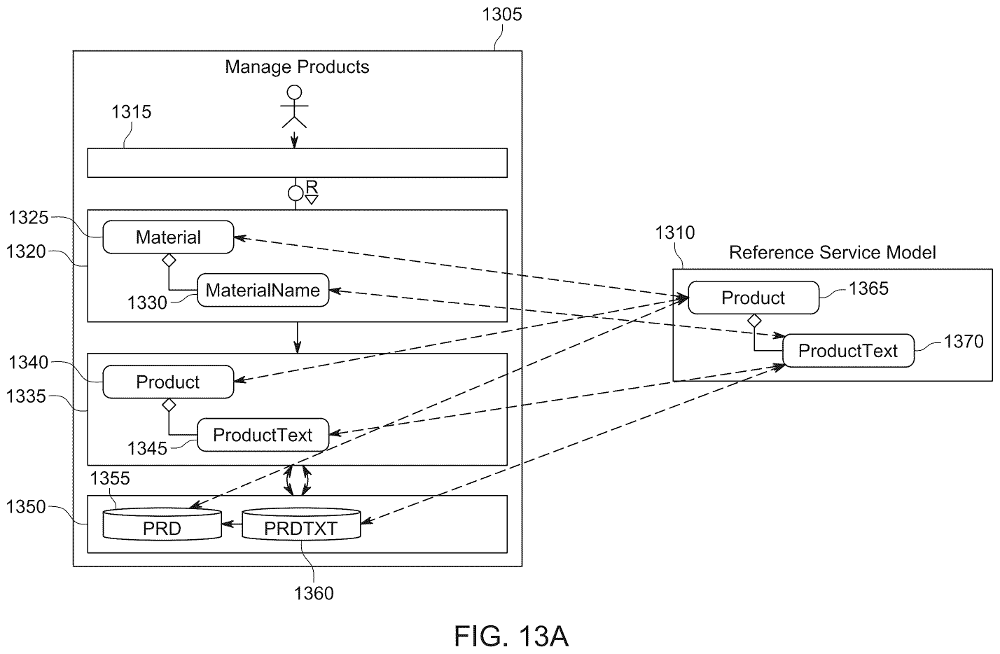

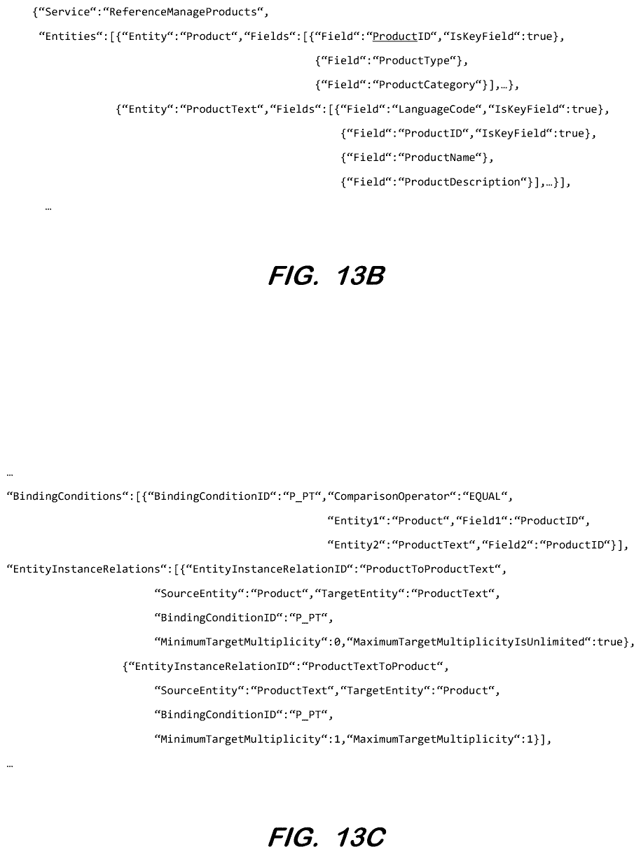

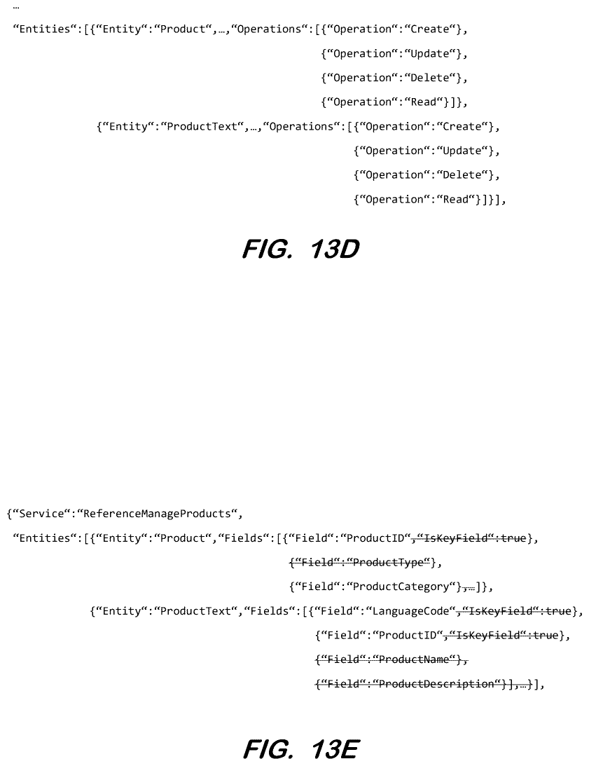

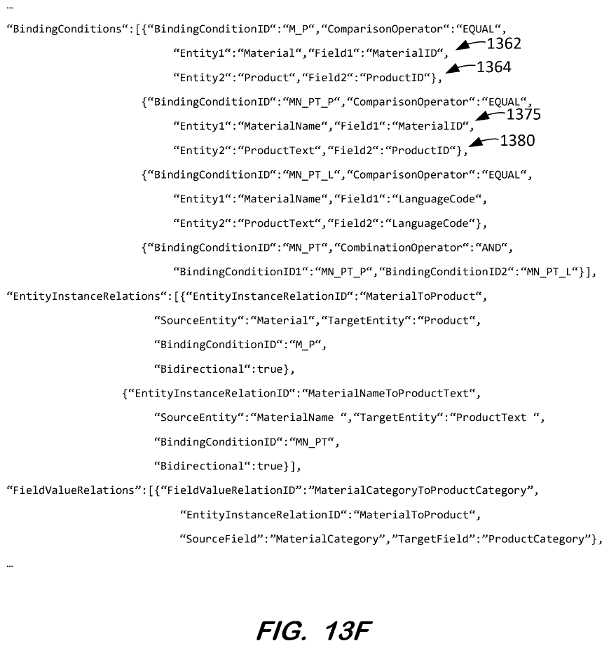

FIG. 13A is an illustrative depiction of an application stack 1305 for a Manage Products application and a reference service model 1310 used thereby. FIG. 13A schematically illustrates the dependencies between the services 1320, 1335, and 1350 and the reference service model 1310.

In the example of FIG. 13A, reference service model 1310 may define a model of the services of the application, including the data model along with its operations. The one reference model 1310 may be used to establish mappings from metadata between the individual services through the reference model. Reference service model 1310 might use different names than those depicted in FIG. 13A (i.e., “Product” 1365 and “ProductText” 1370). In some embodiments, a data model of one of the real services 1320, 1335, and 1350 may be used as a reference service mode. In one embodiment, a completely independent model might be defined as a reference model.

As an example, at runtime, a consumer call reaches, via UI 1315, a specific service implementation 1320 that delegates some processing logic to the underlying BO stack 1335, from which a service request is issued to the database system 1350 including database tables 1355 and 1360 for storing “Product” and “ProductText” related data, respectively.

Instead of working the specifics (e.g., naming syntax, etc.) of the individual services, some embodiments herein can process this data flow via reference service model 1310 that bidirectionally maps to all of the services. For example, reference service model 1310 defines how the “Material” entity 1325 and the “MaterialName” entity 1330 are reflected in the reference service model and vice versa. FIG. 13B is an illustrative representation of how service reference model 1310 might define the “Product” 1365 and “ProductText” 1370 entities. FIG. 13C is an illustrative listing of the entity instance relations defined by the reference service model 1310 and FIG. 13D is an illustrative listing representing the operations defined by service reference model 1310.

In some embodiments, note that a reference service model herein might, if used, be constrained to capturing aspects related to access controls. For example, other aspects of a service model not necessary, from a perspective of the DFOAC infrastructure disclosed herein, might not be included in the reference service model.

Important in some aspects, a reference service model is not strictly a data model as previously described herein regarding application services (e.g., an OData service (225), a BO service model (240, 1335), etc.). Since a primary purpose of the reference service model may be to simplify the mapping of access controls, it is not necessarily a full-fledged declaration of a service model but might only reflect the metadata that is relevant for the DFOAC infrastructure. Instead, a service reference model herein is a model that describes access controls. As such, only aspects and features that are actually important or relevant to the access controls might be included in a reference service model. For example, while there might be a quite lot of information, a lot of fields, a lot of entities defining the services 1320, 1335, and 1350, what matters from the DFOAC infrastructure's perspective might be limited to those features and aspects that are access control relevant. Accordingly, from an authorization perspective, a lot of information might not be needed, wherein such information can be dropped from (or otherwise not included in) the reference service model for the sake of simplicity and efficiency. For example, the metadata shown in FIG. 13A-13D could be stripped down to the metadata that is effectively leveraged by the supported access controls. For example, in the reference entity model (i.e., FIG. 13B), the information highlighted in FIG. 13E might be removed since this information will not be interpreted by the access controls.

In some aspects, a reference service model herein may be simplified as compared to that which might be included in a data model for application services. Still, there are aspects and features that should be considered by a reference service model.

In some embodiments, if a real service is not the template for a reference service model, but there is a dedicated reference service model isolated from an existing service model, then mappings between the real service model and the reference service model should be established in both directions.

The mappings between the actual service models and their underlying reference service model may be captured in a declarative manner. In order to establish a mapping from the OData service “ManageMaterials” 1320 to the reference service model “ReferenceManageProducts” 1310, terms like “Material . . . ” used therein will be replaced with “Product . . . ”. For example, entity “Material” is bound to entity “Product”. Similarly, the entity “MaterialName” is to be mapped onto entity “ProductText” of the reference service model. In some embodiments, the resulting mapping data may be represented as illustrated in FIG. 13F. As shown in FIG. 13F, mappings are defined to, for example, equate “MaterialID” field of entity “Material” 1362 in the “ManageMaterial” service 1320 to the ProductID field of entity “Product” 1364 in the reference service model 1310. Similarly, the “ManageMaterial” service has the field “MaterialID” of its entity “MaterialName” 1375 and the field “ProductID” of the entity “ProductText” 1380 of the reference service model mapped to each other. Similar mappings are defined between other fields in the “ManageMaterial” service 1320 and the referenced service model 1310. Additional mappings are defined for entity instance relations, including bidirectional bindings (i.e., “Bidirectional”:true).

In some embodiments, where all service models are mapped bidirectionally onto their associated reference service model, the service models might be mapped onto one another. As such, direct relations may be established between the different services in the DFOAC processing herein. Applying the reference model approach, the common reference service model should be supported/interpreted by the individual services using the DFOAC infrastructure. By doing so, it may not be necessary to interpret the specific access control information of the invoked services themselves. Instead, the mapping of the access controls of the actually invoked services can be delegated to the DFOAC infrastructure, thereby easing the creation of access contexts. In some embodiments including a fully modelled service environment like the ABAP Restful Application Programming Model (RAP) managed services, the infrastructure might even automatically apply this type of delegation, thereby reducing implementation efforts for the individual applications.

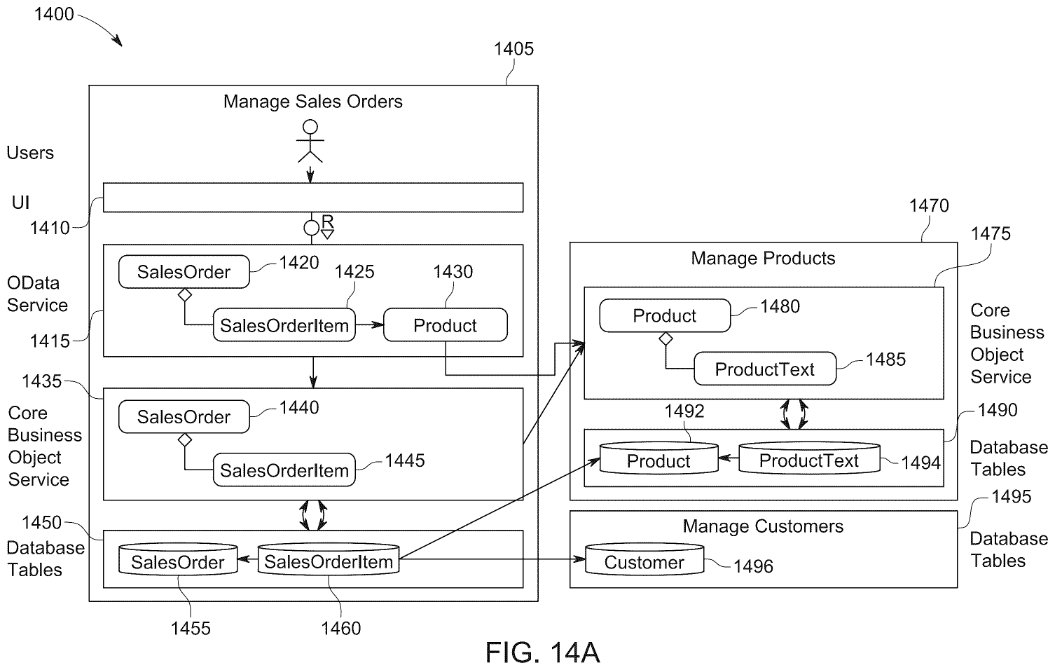

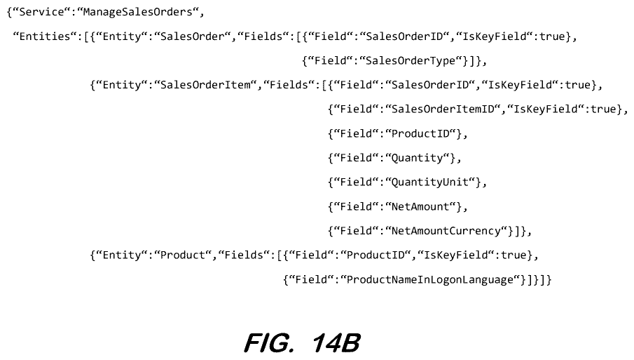

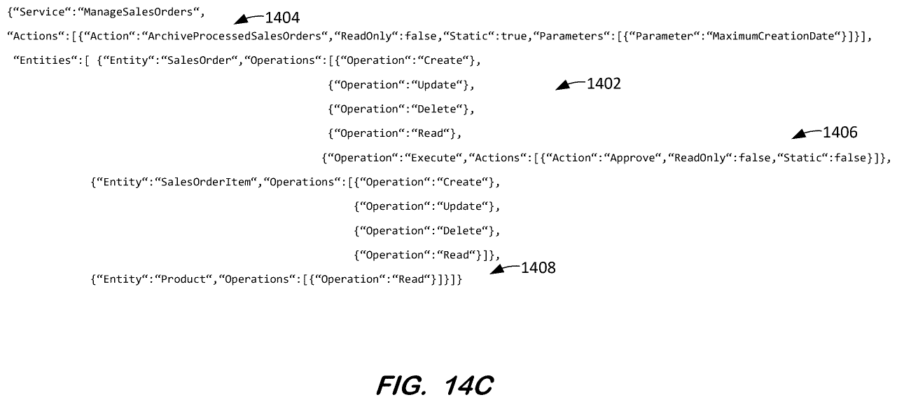

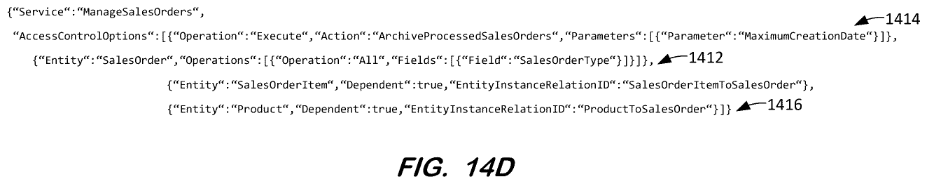

FIG. 14A is an illustrative depiction of an example stack for a Manage Sales Orders application. The example application stack 1400 depicted in FIG. 14A includes more complexity than the previous examples herein. By way of example, various aspects and features of the present disclosure are discussed below with reference to FIG. 14A. Accordingly, some more complex scenarios and extensions of the DFOAC infrastructure will be discussed regarding the application stack 1400.

Referring to FIG. 14A, ManageSalesOrder application 1405 is composed of three different services overall. The ManageSalesOrder application 1405 includes the entities “SalesOrder” 1420, “SalesOrderItem” 1425, and “Product” 1430 on the OData level in one comprehensive service. Additionally, UI 1410 provides a mechanism for a user to interact with the application. The OData service “Manage Sales Orders” 1415 supports the user in maintaining sales orders and is based on the core business object services 1435 for sales orders and 1475 for products. The “Product” entity 1430 is fed by the “ManageProducts” application or service 1470. As further seen, the “SalesOrder” 1420 and “SalesOrderItem” 1425 come from the core business object service 1435 (i.e., 1440 and 1445, respectively) and are further distributed to the database system 1450 within dedicated tables 1455 and 1460. Similarly, the Product 1480 and ProductText 1485 of the BO service 1475 of the ManageProducts service are stored and fetched from database tables 1492 and 1494, respectively, of the database storage layer 1490. Apart from the two core BO services 1475 and 1435 for the ManagedProduct service 1470 and the ManageSalesOrders service 1405, there is a connection to a ManageCustomer service 1495 that is realized on a database level including database table 1496. The database logic of the application “Manage Sales Orders” application 1450 leverages the database “Manage Customers” service 1495.

FIG. 14B is an illustrative listing of detailed metadata for the entities of the OData service of the Manage Sales Orders service in FIG. 14A. In addition to the entities “SalesOrder” and “SalesOrderItem”, the OData service 1415 comprises the entity “Product” that provides the key “ProductID” and the product name in the logon language of the user “ProductNameInLogonLanguage”.

FIG. 14C provides an example of the operations defined for the Manage Sales Order application. As shown, the operations include core operations of create, update, delete and read at 1402, as well as some defined actions as seen at 1404 and 1406. In this example, there is an action on the service level called “ArchiveProcessedSalesOrders”. It is a static action, meaning it is not attached to any record of the sales order and is just attached to the service itself. As defined, this action is not read only, so it's a changing service (e.g., a writing service). It has one parameter that controls the execution. Namely, the date up to which sales orders are selected to be archived. Similarly, there is a defined action at 1406 that is instance bound (i.e. static=false) that is attached to the entity “SalesOrder” and is further defined as an approval action “Approval” based on the “SalesOrder” entity. For the “Product” entity of the “ManageSalesOrder” service, the only operation permitted via the service is a read of the data as shown at 1408.

FIG. 14D is an illustrative representation of metadata defining the access control options for the present example. Referring to FIG. 14D, access to all of the contained OData entities is determined by field “SalesOrderType” of entity “SalesOrder” as seen at 1412. The defined access control also applies to the entity “Product” (i.e., users allowed to access the sales order data may also access the associated data of the entity “Product” in privileged mode). As defined at 1416, the entity Product is a dependent entity and a user shall not be able to read any product that is in the system, but the user can read products that have a relation to a SalesOrder where the sales order access options are defined by the sets order type. Accordingly, if a user requests information for a product, a check will be performed to determine whether this product is associated with a sales order that has a specific sales order type for which the user is authorized access. Otherwise, the user will not be granted access to read information about the product that is completely independent of the sales order. Also, the action execution can be controlled by its input parameter “MaximumCreationDate”, as seen at 1414.

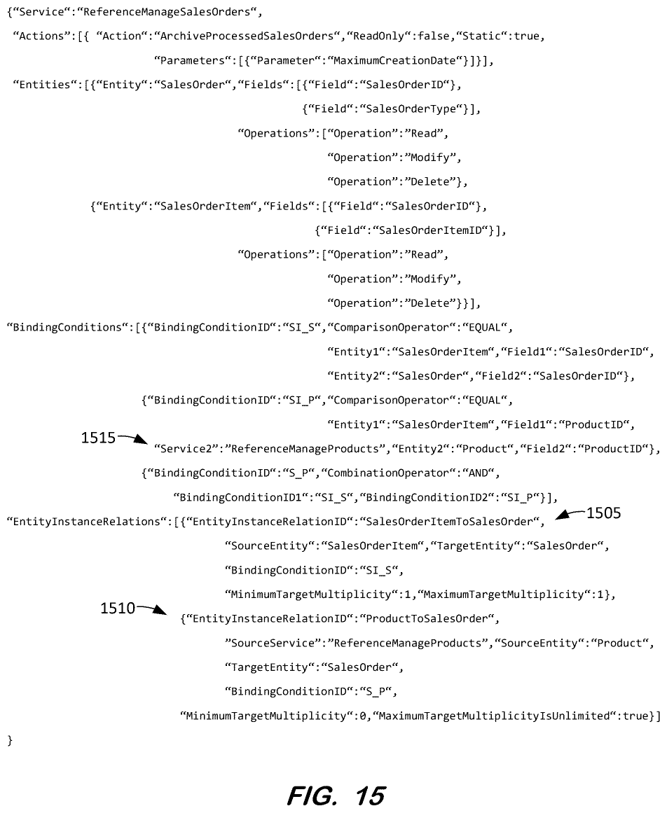

Merely from an access control perspective, the corresponding reference model for sales orders could be represented as illustrated in FIG. 15. FIG. 15 defines a reference model “ReferenceManageSalesOrders” for the sales orders. Recalling, as mentioned above, a reference model need not include all of the attributes of a service data model, the reference model of this example may primarily include information that is relevant from an authorization perspective. For example, from an authorization perspective, the reference model might just need the fields “SalesOrderID” and the “SalesOrdereItemID” for the entity “SalesOrderItem”.

As shown in FIG. 15, a relation from the entity “SalesOrderItem” to entity “SalesOrder” is defined at 1505. Also, a relation from entity “Product” of the reference service model of products “ReferenceManageProducts” to the entity “SalesOrder” is defined at 1510. Both these relations are required for capturing the access context.

While the “Product” entity is not a part of the SalesOrder (the “Product” will have its own reference model), some related aspects of the “Product” are captured as seen at 1505. As defined, a SalesOrderItem entity is within this service and there is a field ProductID that has a relation not to a field in this reference service, but to the reference service of the “Products” (i.e., “ReferenceManageProducts”) that includes the field “ProductID”, as seen at 1515. As further shown, the field “ProductID” is related to the field “SalsesOrderID”.

As seen, in some aspects, there is a pointer from this reference model to another reference model. Such relationships may be used in further processing of service requests in an efficient manner, while maintaining desired access controls.

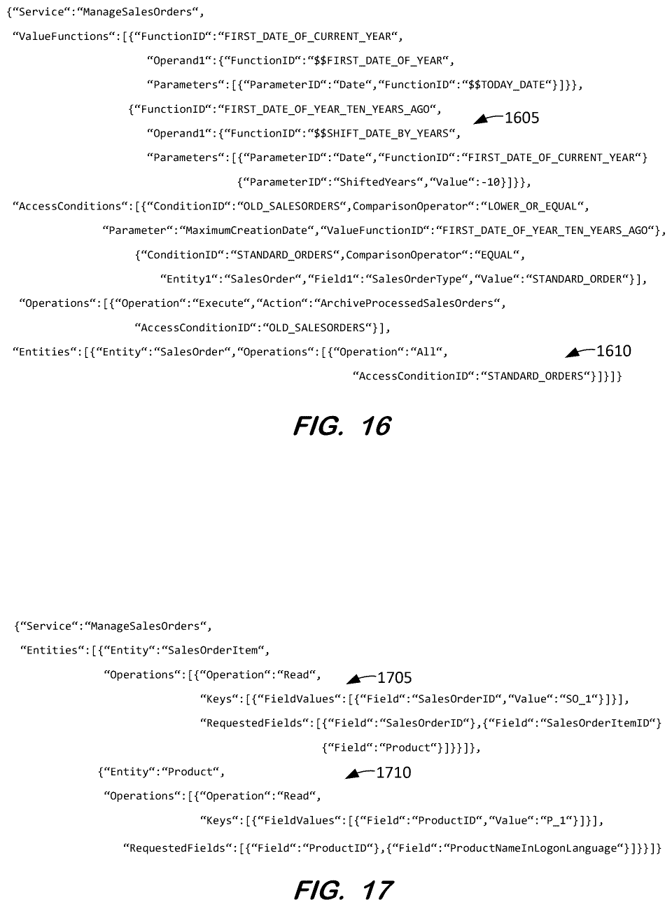

Having described and defined the service model (FIG. 14B), the service operations (FIG. 14C), the access controls for the service (14D), and the reference model to be used by the service (FIG. 15), FIG. 16 provides an illustrative example of how a user might be authorized in this present example, including some additional features that may be provided by the access control framework herein.

In this example, there is an action to be controlled from an authorization perspective. There is a parameter that is related to a date and there is a specific requirement to grant users authorization to archive sales orders that are no longer needed, which from an auditing perspective may typically be 10 years. As such, sales orders should be retained in the system and users should be granted authorization to archive all records older than 10 years. Accordingly, the user may archive sales orders that were created more than ten years ago. This access restriction is defined using a predefined function “$ $SHIFT_DATE_BY_YEARS” offered by the DFOAC that provides an up-to-date evaluation result influencing the authorizations of the user. In some aspects, the DFOAC infrastructure disclosed herein may support various different built-in functions for defining user authorizations. For example, DFOAC herein may offer aggregation functions such as $ $SUM (summation) and $$MAX (maximum value) for defining user authorizations. These (and other) functions may, for example, be applied for restricting access to Sales Orders for which the total net amount is below a predefined limit such as 10000 Euros.

In the present example, the access control can also use functions. As an example, a function might determine the current date. In some aspects, the DFOAC disclosed herein may provide one or more predefined functions for evaluations and access enforcements that are supported by the disclosed framework. In some aspects, functions might use special characters to indicate that there are some predefined functions in place, as seen at 1605. The listed functions in the present example of FIG. 16 are just examples of the types of functions that might be enabled herein and to demonstrate the power and flexibility of authorization enforcement herein. For example, nested functions are possible as seen in FIG. 16. The listed functions in FIG. 16 determine the first date of the current year and the first date 10 years ago (shown at 1605).

In some aspects, the use of functions provides a mechanism to control access authorizations based on dynamic features (i.e., features and criteria that might change), where changes in values can be determined without additional changes to the definitions by an administrator, developer, and/or other entity.

In accordance with FIG. 16, the defined functions therein may be used to implement specific controls on a service to allow, for example, a manger to approve sales orders only if the costs are below a certain limit or threshold that can be determined by the listed functions (e.g., a summation or calculation of the maximum value) where sales orders less than, for example, €10,000 can be approved. For sales orders in excess of this amount, the user will have no approval authorization.

As further defined in FIG. 16 at 1610, a user can access the remaining functionality of the OData service for sales orders of type “STANDARD_ORDER”.

FIG. 17 is an example of a user issued OData service request that includes two read operations 1705 and 1710. Read operation 1705 is defined to read certain info from the “SalesOrderItem” entity and read operation 1710 is defined to read certain info from the “Product” entity where the product id and the product name in the logon language of the user are requested, respectively. Both of the read requests in FIG. 17 can only be indirectly mapped onto the user authorizations defined at the entity “SalesOrder”.

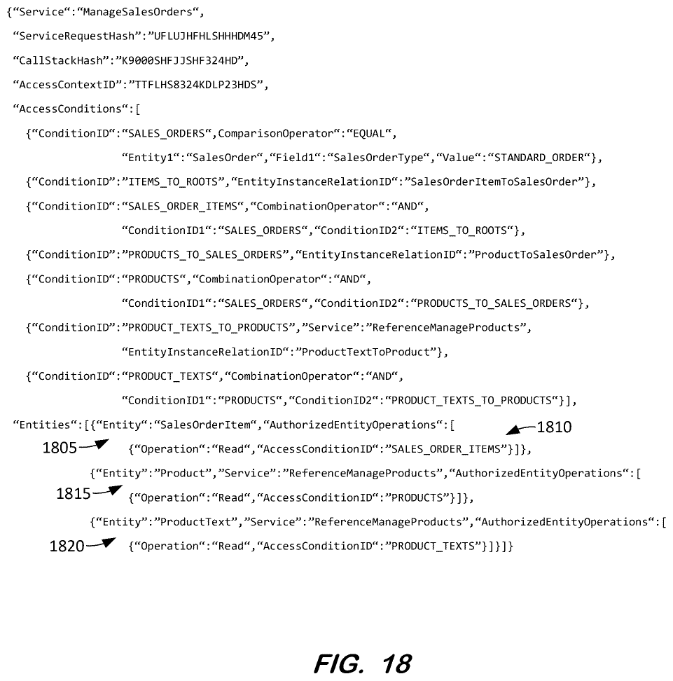

FIG. 18 is an illustrative example of the corresponding access context for the “Manage Sales Orders” application. In this example listing, the access context defines a number of conditions that may be used in defining the access controls for one or more entities related to the service. For example, for accessing the entity “SalesOrderItem” (shown at 1805), the access conditions “SALES_ORDER_ITEMS” (shown at 1810) must be checked. For constructing the OData entity “Product” of service “ManageSalesOrders” both entities “Product” (shown at 1815) and “ProductText” (shown at 1820) of the service “ReferenceProductManage” must be accessed. The corresponding requests are subject to the access conditions “PRODUCTS” and “PRODUCT_TEXTS”, respectively, which are finally mapped on the “SalesOrderType”=“STANDARD_ORDER”, similar to the read access to the entity “SalesOrderItem”.

In some aspects, the example of FIG. 18 demonstrates how reference service models herein may be combined for constructing access contexts.

In some embodiments, certain extension options and customer specific or partner specific implementations may be integrated into the DFOAC infrastructure or framework disclosed herein using a number of different options.

As disclosed herein, a service may be associated with access control options defined for the service. In some embodiments, there may be an option to overrule the access control options (i.e., access context). For example, there may be a desire to not use the standard access control options associated with a service, but instead use a different and independent set of access control options. In one embodiment, this type of switch might be achieved by defining a “Replacement” type of access control option that would, at runtime, replace all of the existing access control option with another set of access control options.

In some instances, an existing access control might be enriched by, for example, (1) merging some desired access controls with the existing access controls via a “Merge” type of option and (2) combining access controls with an Alternative type of option. With the “Merge” option, both of the access controls will be enforced (i.e., a logical AND condition) and the “Alternative” option is equivalent to a logical OR condition between the two access control options.

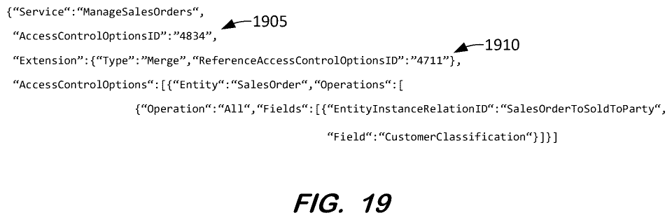

FIG. 19 is an illustrative example demonstrating how access control options might be combined to construct desired access controls. For the example of FIG. 19, it may be assumed that the beforementioned access control (e.g., FIG. 18) is insufficient in the context of a specific customer installation. For example, the customer does not only want to restrict the accesses within the OData service “ManageSalesOrders” based on the sales order types but also restrict access based on the classification of the sold-to-parties. In the present example, the customer classification shall be used as an additional criterion, as seen in FIG. 19. Per FIG. 19, the entity instance relation “SalesOrderToSoldToParty” points from the reference sales order model to the reference service model “ReferenceCustomer” (not shown). The extensions get their an own ID “AccessControlOptionsID” (shown at 1905) and reference other access control options “ReferenceAccessControlOptionsID” (shown at 1910). In this way, access control options herein might be deeply nested.

Note that the foregoing and other types of access control options (e.g., Split option to split/filter out some parts of an access control context, etc.) might be provided in accordance with the present disclosure. In some aspects, logic extensions herein might be implemented by DFOAC plugins.

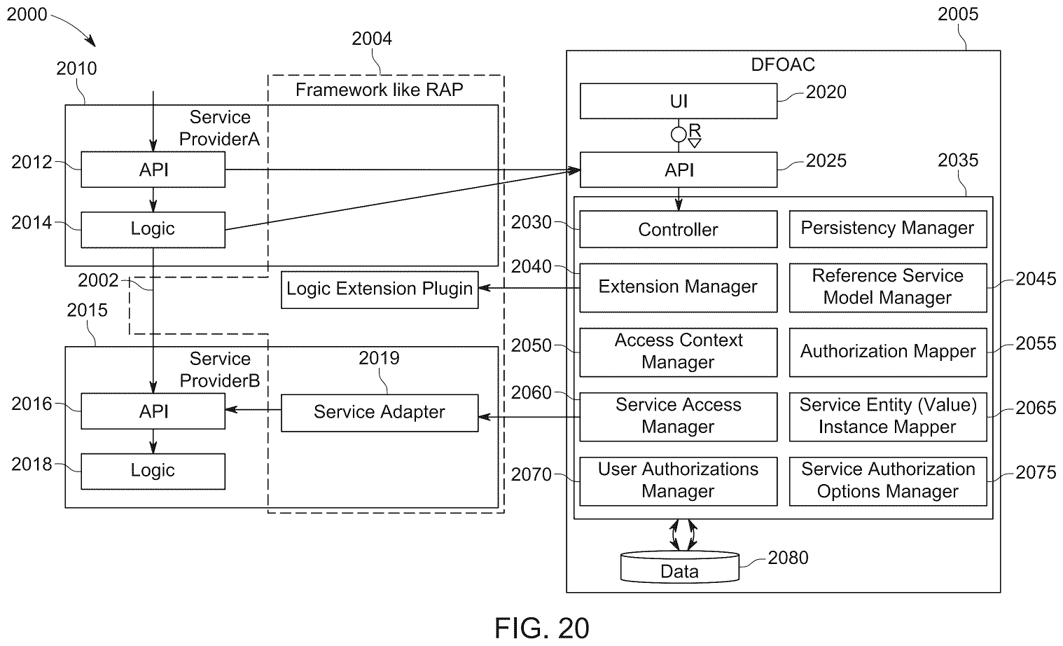

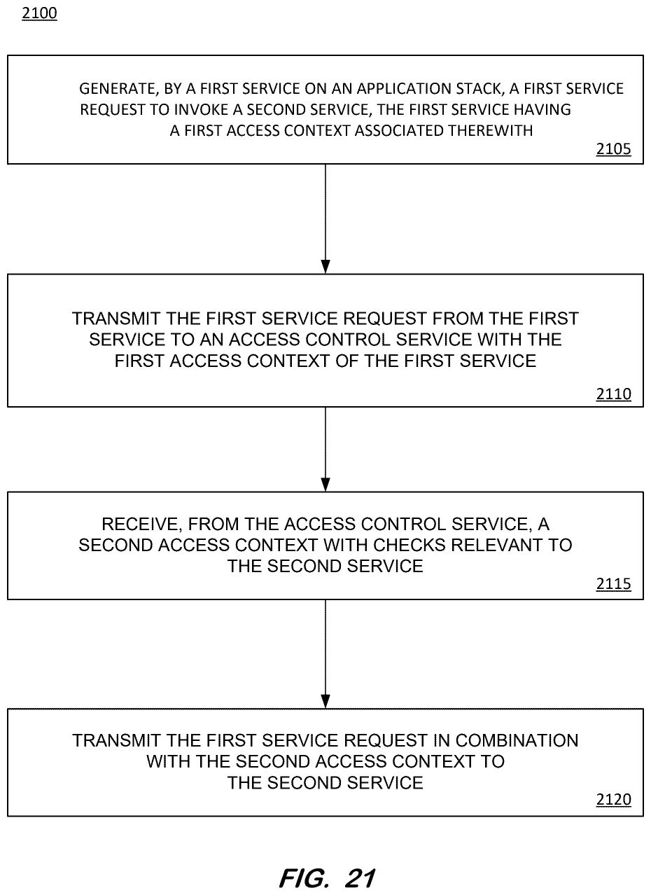

FIG. 20 is an illustrative depiction of an overall architecture 2000 for supporting some embodiments of the systems and processes disclosed herein (i.e., the DFOAC architecture). Referring to the example embodiment of FIG. 20, a number of components of infrastructure 2005 are illustrated. In some embodiments, the disclosed infrastructure 2005 may be realized as a standalone service (e.g., on a cloud-based technology platform) that connects to one or more service providers for providing access controls to the functions of the services and the data manipulated thereby.

The illustrative system depicted in FIG. 20 includes a Service Provider A 2010 with its API (Application Programming Interface) 2012 and internal application logic 2014 and a Service Provider B 2015 with an API 2016 and internal application logic 2018. In some aspects, the specific components of the DFOAC infrastructure 2005 may be used within the processing logic of the access controls disclosed herein.

As illustrated, infrastructure 2005 includes one or more UIs 2020 for maintaining metadata, for defining user authorizations, and the like that make up this infrastructure. In some aspects, the DFOAC infrastructure herein provides a set of tailored UI applications that enable administrators to configure the functionality of the DFOAC, as well as to display and maintain authorizations for end users. These end-user facing UI applications may delegate their requests for reading and updating data via dedicated, tailored API(s) 2025 to the various components implementing the logic of the DFOAC services. In some aspects, API(s) 2025 may be consumed from the UI application 2020, as well as within the logic of the services (e.g., service A) that can leverage the DFOAC infrastructure. In some instances, when a DFOAC API is invoked by a service, the DFOAC service is delegating the call to the controller 2030. Controller 2030 may act as the primary processing functionality for mapping the service requests to the internal DFOAC functionality. In some aspects, it orchestrates the entire processed functionality. As such, controller 2030 can dispatch and orchestrate the further processing of the call using the other components of the system architecture (e.g., persistency manager 2035 that controls all database processing, such as data selections and data updates, within the DFOAC infrastructure). Reference service model manager 2045 manages and controls the service reference models, including defining reference service models and their mappings onto the regular application services. Extension manager 2040 manages extension options of the DFOAC governed access controls that, for example, might inject logic into the access enforcement to assert more finely tuned access control(s) than might be available with a declarative approach. In some aspects, during runtime the extension manager may also invoke plugged-in exits that implement the envisioned extension logic. Access context manager 2050 creates and manages the access control contexts, including capturing service specific access contexts. In some aspects, it establishes and returns trusted access contexts that service providers can rely upon. As demonstrated by the examples herein, there may be embodiments that involve extensive mapping for the authorizations of a user, which is handled by the processing functionality embodied in the Authorization mapper 2055. Service entity (value) instance mapper 2065 handles mappings of needed values, including mapping service requests onto user authorizations and evaluating related conditions such as the conditions captured in the service models and establishing bindings on entity instance levels, respectively.

User authorizations manager 2070 may handle the definitions and analysis of user authorizations. Service authorization options manager 2075 may capture the supported authorization options for each supported service. Moreover, the service authorization options manager may expose the supported authorization options for each relevant service in a declarative manner. Data generated and processed by the DFOAC infrastructure may be stored at and retrieved from database 2080.

In some scenarios, there may be a callback mechanism in place where a call will be routed via service access manager 2060 that routes service requests from consumers leveraging the DFOAC APIs to service providers via specific service adapters (e.g., service adapter 2019). The access manager will then invoke API 2016 of service provider B instead of the service provider A doing it. This scenario is an option since, as seen in FIG. 20, there may be an option of a service (e.g., Service A), via direct path 2002, (and specifically for some (legacy) applications) to invoke the API of Service B.

Depending on the DFOAC instrumentation of the service providers, service calls can be processed in different ways. Some aspects of service provider interaction will now be discussed in the context of FIG. 20. As an example, Service Provider A shall receive a direct call of its API 2012 by its consumer. Service Provider A then fetches the current access context from the DFOAC API 2025. If an access context was constructed from the caller, then this access context will be returned. Otherwise, a new access context may be automatically constructed by the DFOAC infrastructure. The received access context may then be considered within the processing logic 2014 of service provider A.

In some aspects, if Service Provider A wants to invoke Service Provider B, there are basically two service interaction flows. In one interaction sequence, Service Provider A delegates the actual service invocation of Service Provider B via the DFOAC API 2025, which in turn invokes DFOAC controller 2030. After a new access context is constructed via access context manager 2050, the DFOAC service access manager 2060 is instructed to dispatch the service request along with the newly constructed access context via DFOAC service adapter 2019 of service provider B to its API 2016.

Alternatively, Service Provider A may delegate a call to Service Provider B by requesting the creation of a new access context in its logic 2014 viaDFOAC API 2025 of the infrastructure 2005 and receives the access context from the infrastructure. Service Provider A then directly invokes the services of Service Provider B via its API 2016 and provides the received access context with the service request to Service Provider B in a call to API 2016.

In some aspects, if services are implemented by using frameworks such as the RAP infrastructure 2004, the framework may take over the implementation of DFOAC service adapters and DFOAC extensions, as well as their automatic invocations, such that the DFOAC allows a fully modelled access control handling without application specific coding.

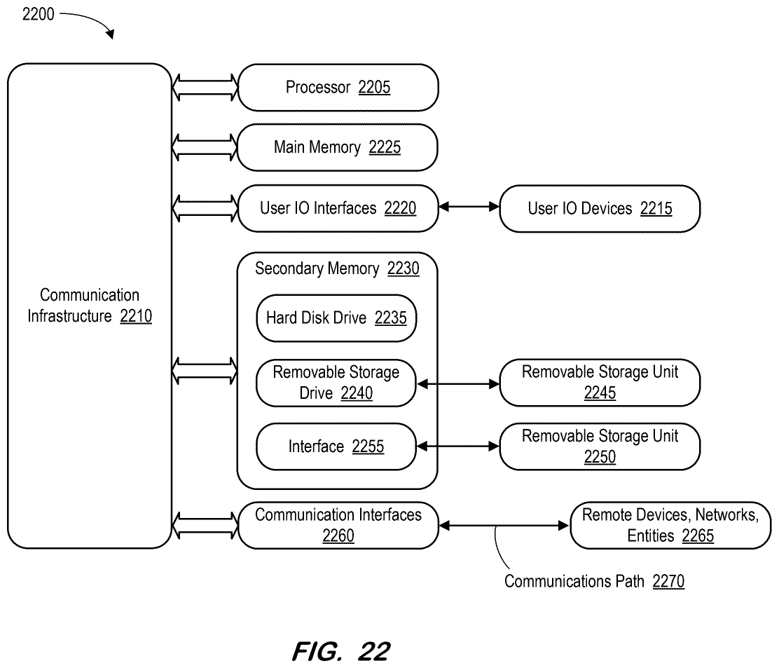

FIG. 21 is an illustrative flow diagram for a process 2100 related to a DFOAC infrastructure, according to an example embodiment. In some aspects, process 2100 includes features of a sequence of interactions between services integrated with a DFAOC infrastructure (e.g., service) as disclosed herein. In some regards, the aspects of process 2100 been introduced hereinabove and disclosed in great detail, particularly in the context of the many illustrative examples introduced and discussed fully above. As such, a further understanding of process 2100 may be understood by referencing the examples illustrated in, for example, FIGS. 13A, 14A, and architecture 2200 in FIG. 22, as well as the corresponding detailed discussion of same herein. Accordingly, the following discussion of process 2100 will primarily avoid repeating detailed aspects disclosed elsewhere in the present disclosure, not as an indication that other aspects and features are not or cannot be included in some embodiments of process 2100 but rather as a matter of clarity and conciseness.

At operation 2105, a first service request is generated by a first service within an application stack. The first service request serves to invoke a second service. In some embodiments, the first service and the second service may both be contained within the same application stack. In some other embodiments, the first and second services may be on different application stacks. In some instances, the first service request may originate at the first service. In other instances, the first service request might be a part of a processing data flow wherein the first service passes the first service request to the second service, either unchanged or modified at least in part. In accordance with other aspects disclosed herein, the first service is associated with a first access context, wherein the first access context defines one or more access control options for the functions and data related to the first service. As disclosed in great detail above, the access context may be defined by metadata associated with the first service. As further disclosed above, the first access context is defined specifically for the first service and the particular entities and functions of the first service.

At operation 2110, the first service request is transmitted or otherwise routed to an access control service. Per the numerous examples above, the DFOAC infrastructure disclosed herein may implement the access control service recited in process 2100. Accordingly, the access control service may implement one or more of the functionalities disclosed herein as being embodied and/or implemented by the DFOAC of the present disclosure. In some embodiments, the various functionalities of the DFOAC might be combined, including configurations not explicitly depicted in some of the examples herein, to effectuate the operations attributed thereto in process 2100.

Continuing to operation 2115, a second access context is received by the first service from the access control service, wherein the second access context is specifically-defined for the second service that will be invoked by the first service request. As disclosed above, the second access context may define authorization checks that are strictly relevant to functions and data of the second service. In some aspects, a metadata model of the second access context may be mapped to a metadata model of the second service. In some instances, a reference service model (e.g., FIGS. 13A, 1310) may be leveraged by the access control service (e.g., DFOAC infrastructure) to efficiently define access controls tailored to the second service (and other services as well).

At operation 2120, the first service request may transmit or otherwise pass the second access context to the second service. In some embodiments, the first service may pass the second access context directly to the second service, for example via APIs of each service. In some other embodiments, the service request transmitted in operation 2120 might be passed to the second service via the access control service. In either case, the service request is transmitted to the second service in combination with the second access context defined specifically for the second service (as opposed to the first access context originally included with the service request from the first service). In this manner, the invoked second service may be equipped to perform only the authorizations checks necessary for the execution of its processing logic.

Various embodiments of a DFOAC infrastructure disclosed herein may be implemented, for example, using one or more computer systems, such as computer system 2200 shown in FIG. 22. The computer system 2200 can be any computer capable of performing the functions described herein. Computer system 2200 includes one or more processors (also called CPUs), such as a processor 2205. Processor 2205 is connected to a communication infrastructure or bus 2210.

One or more processors 2205 may each be a Graphics Processing Unit (“GPU”). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 2200 also includes user input/output device(s) 2215, such as monitors, keyboards, pointing devices, etc., that communicate with communication infrastructure xx06 through user input/output interface(s) 2220.

Computer system 2200 also includes a main or primary memory 2225, such as Random-Access Memory (“RAM”). Main memory 2225 may include one or more levels of cache. Main memory 2225 has stored therein control logic (i.e., computer software) and/or data.

Computer system 2200 may also include one or more secondary storage devices or memory 2230. Secondary memory 2230 may include, for example, a hard disk drive 2235 and/or a removable storage device or drive 2240. Removable storage drive 2240 may be a floppy disk drive, a magnetic tape drive, a compact disk drive, an optical storage device, tape backup device, and/or any other storage device/drive.

Removable storage drive 2240 may interact with a removable storage unit 2245. Removable storage unit 2245 includes a computer usable or readable storage device having stored thereon computer software (control logic) and/or data. Removable storage unit 2245 may be a floppy disk, magnetic tape, compact disk, DVD, optical storage disk, and/any other computer data storage device. Removable storage drive 2240 reads from and/or writes to removable storage unit 2245 in a well-known manner.

According to an exemplary embodiment, secondary memory 2230 may include other means, instrumentalities or other approaches for allowing computer programs and/or other instructions and/or data to be accessed by computer system 2200. Such means, instrumentalities or other approaches may include, for example, a removable storage unit 2250 and an interface 2255. Examples of the removable storage unit 2250 and the interface 2255 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 2200 may further include a communication or network interface 2260. Communication interface 2260 enables computer system 2200 to communicate and interact with any combination of remote devices, remote networks, remote entities, etc. (individually and collectively referenced by reference number 2265). For example, communication interface 2260 may allow computer system 2200 to communicate with remote devices 2265 over communications path 2270, which may be wired and/or wireless, and which may include any combination of LANs, WANs, the Internet, etc. Control logic and/or data may be transmitted to and from computer system 2200 via communication path 2270.

In an embodiment, a non-transitory tangible apparatus or article of manufacture comprising a tangible computer useable or readable medium having control logic (software) stored thereon is also referred to herein as a computer program product or program storage device. This includes, but is not limited to, computer system 2200, main memory 2225, secondary memory 2230, and removable storage units 2245 and 2250, as well as tangible articles of manufacture embodying any combination of the foregoing. Such control logic, when executed by one or more data processing devices (such as computer system 2200), causes such data processing devices to operate as described herein.

Based on the present disclosure, it will be apparent to persons skilled in the relevant art(s) how to make and use embodiments of the invention using data processing devices, computer systems and/or computer architectures other than that shown in FIG. 22. In particular, embodiments may operate with software, hardware, and/or operating system implementations other than those described herein.

Although specific hardware and data configurations have been described herein, note that any number of other configurations may be provided in accordance with some embodiments of the present invention (e.g., some of the information associated with the databases and storage elements described herein may be combined or stored in external systems). Moreover, although some embodiments are focused on particular types of applications and services, any of the embodiments described herein could be applied to other types of applications and services. In addition, the displays shown herein are provided only as examples, and any other type of user interface could be implemented. Embodiments are therefore not limited to any specific combination of hardware and software.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

Embodiments disclosed herein are solely for the purpose of illustration. Those in the art will recognize other embodiments may be practiced with modifications and alterations to that described above.

What is claimed is:

1. A computer-implemented method, the method comprising:
generating, by a first service on an application stack, a first service request to invoke a second service, the first service having a first access context associated therewith that defines authorization checks related to functions performed by and data processed by the first service;
transmitting the first service request to invoke the second service from the first service to an access control service, the first service request being transmitted with the first access context of the first service;
receiving, from the access control service, a second access context, the second access context defining authorization checks relevant to functions and data processing to be performed by the second service to fulfill the first service request; and
transmitting the first service request in combination with the second access context to the second service, the second service enabled to execute the first service request using authorization checks defined in the second access context.

2. The method of claim 1, wherein the authorization checks included in the second access context are strictly applicable to the second service.

3. The method of claim 1, further comprising persisting the second access context in a data store, the persisted second access context including an indication of authorization checks previously executed to completion by the first service.

4. The method of claim 1, further comprising:
receiving, by the first service, a second service request from another service prior to the generating of the first service request, the second service request including a third access context associated with the other service and defining authorization checks related to second service request; and
generating, by one of the first service and the access service, a fourth access context based on the third access context, including an indication of authorization checks previously executed to completion by the other service, functions to be performed by the first service to fulfill the second service request, and at least one access control option of the first service.

5. The method of claim 1, wherein the first access context and the second access context are generated specifically for the first service and the second service, respectively.

6. The method of claim 1, wherein the first access context and the second access context are generated based on metadata associated with and defining entities of the respective first and second services, relationships between the entities of the respective first and second services, and access controls of the respective first and second services.

7. The method of claim 6, wherein the metadata associated with each of the first access context and the second access context are mapped to a same reference service model.

8. A system comprising:
at least one programmable processor; and
a non-transitory machine-readable medium storing instructions that, when executed by the at least one programmable processor, cause the at least one programmable processor to perform operations comprising:
generating, by a first service on a first application stack, a first service request to invoke a second service, the first service having a first access context associated therewith that defines authorization checks related to functions performed by and data processed by the first service;
transmitting the first service request to invoke the second service from the first service to an access control service, the first service request being transmitted with the first access context of the first service;
receiving, from the access control service, a second access context, the second access context defining authorization checks relevant to functions and data processing to be performed by the second service to fulfill the first service request; and
transmitting the first service request in combination with the second access context to the second service, the second service enabled to execute the first service request using authorization checks defined in the second access context.

9. The system of claim 8, further comprising persisting the second access context in a data store, the persisted second access context including an indication of authorization checks previously executed to completion by the first service.

10. The system of claim 8, further comprising:
receiving, by the first service, a second service request from another service prior to the generating of the first service request, the second service request including a third access context associated with the other service and defining authorization checks related to second service request; and
generating, by one of the first service and the access service, a fourth access context based on the third access context, including an indication of authorization checks previously executed to completion by the other service, functions to be performed by the first service to fulfill the second service request, and at least one access control option of the first service.

11. The system of claim 8, wherein the first access context and the second access context are generated specifically for the first service and the second service, respectively.

12. The system of claim 8, wherein the first access context and the second access context are generated based on metadata associated with and defining entities of the respective first and second services, relationships between the entities of the respective first and second services, and access controls of the respective first and second services.

13. The system of claim 12, wherein the metadata associated with each of the first access context and the second access context are mapped to a same reference service model.

14. A non-transitory, computer readable medium storing instructions, which when executed by at least one processor cause a computer to perform a method comprising:
generating, by a first service on a first application stack, a first service request to invoke a second service, the first service having a first access context associated therewith that defines authorization checks related to functions performed by and data processed by the first service;
transmitting the first service request to invoke the second service from the first service to an access control service, the first service request being transmitted with the first access context of the first service;
receiving, from the access control service, a second access context, the second access context defining authorization checks relevant to functions and data processing to be performed by the second service to fulfill the first service request; and
transmitting the first service request in combination with the second access context to the second service, the second service enabled to execute the first service request using authorization checks defined in the second access context.

15. The medium of claim 14, wherein the authorization checks included in the second access context are strictly applicable to the second service.

16. The medium of claim 14, further comprising persisting the second access context in a data store, the persisted second access context including an indication of authorization checks previously executed to completion by the first service.

17. The medium of claim 14, further comprising:
receiving, by the first service, a second service request from another service prior to the generating of the first service request, the second service request including a third access context associated with the other service and defining authorization checks related to second service request; and
generating, by one of the first service and the access service, a fourth access context based on the third access context, including an indication of authorization checks previously executed to completion by the other service, functions to be performed by the first service to fulfill the second service request, and at least one access control option of the first service.

18. The medium of claim 14, wherein the first access context and the second access context are generated specifically for the first service and the second service, respectively.

19. The medium of claim 14, wherein the first access context and the second access context are generated based on metadata associated with and defining entities of the respective first and second services, relationships between the entities of the respective first and second services, and access controls of the respective first and second services.

20. The medium of claim 19, wherein metadata associated with each of the first access context and the second access context are mapped to a same reference service model.
